(19) United States
(12) Patent Application Publication
(10) Pub. No.: US 2008/0168051 A1
(43) Pub. Date: Jul. 10, 2008

(54) Systems and methods for sharing information

(75) Inventors: Qingfeng Huang, San Jose, CA (US); James E. Reich, San Francisco, CA (US); Dirk Balfanz, Redwood City, CA (US)

Correspondence Address: PVF -- PARC;c/o PARK, VAUGHAN & FLEMING LLP, 2820 FIFTH STREET, DAVIS, CA, 95618-7759, US

(73) Assignee: Palo Alto Research Center Incorporated

(21) Appl. No.: 11/650,767

(22) Filed: Jan. 8, 2007

(51) Int. Cl. G06F 17/30

(52) U.S. Cl. 707/5; 707/E17.008

(57) ABSTRACT

Techniques are provided for creating and sharing information about arbitrary documents. A primary document is selected and a document content identifier generated based on the content of the primary document. Additional information such as comments, additional documents, reviews and the like are created and/or selected from an information repository. The additional information is associated with the primary document based on the document content identifier of the primary document. A search for information associated with the primary document compares the document content identifier of the primary document to document content identifiers associated with the additional information. Additional information associated with the document content identifiers matching the primary document content identifier is retrieved and displayed to the user.

### BACKGROUND OF THE INVENTION

1. Field of Invention

This invention relates to information access.

2. Description of Related Art

Conventional systems for reviewing and pursuing discussions about documents are created to focus on a particular piece of content and typically identify the content under review by a static link, uniform resource locator or filename. When the name or the location of the file is changed, the file may no longer be accessible at the specified link, and if the content is acquired using some other means, e.g. by scanning a paper copy, or transferring via a portable storage medium, it will not be possible to identify the document to allow participation in the discussion or review process. Some conventional systems require the coordination and enforcement of naming conventions to ensure the files are accessible. However, these naming conventions can make it difficult to extend the system to handle new types of files or media. Thus, systems and method for creating and sharing arbitrary information about arbitrary documents, regardless of where they are stored or how they are acquired, would be useful.

### SUMMARY OF THE INVENTION

The systems and methods of this invention provide for creating and sharing information about arbitrary documents. A primary document is selected and a document content identifier generated based on the actual content of the primary document rather than secondary characteristics such as filename or location. At the time this document identifier is first provided to a service provider or central information repository, topic-specific information stores and/or discussion forums are created which are accessible to further users such that they can add further comments, reviews or links to other relevant documents by accessing a known information repository, service provider or worldwide web Uniform Resource Locator (URL). The additional information is associated with the primary document based on the document content identifier of the primary document. A search for information associated with the primary document compares the document content identifier of the primary document to document content identifiers associated with the additional information. Additional information associated with the document content identifiers matching the primary document content identifier is retrieved and displayed to the user and the user may add additional information to the repository if he or she is permitted to do so by the security policies of the repository.

### BRIEF DESCRIPTION OF THE DRAWINGS

FIG. 1 is an exemplary overview of a system for creating and sharing information according to this invention;

FIG. 2 is an exemplary method for creating and sharing information according to this invention;

FIG. 3 is an exemplary method for displaying information according to this invention;

FIG. 4 is an exemplary method for creating and sharing information according to this invention;

FIG. 5 is an exemplary system for creating and sharing information according to this invention;

FIG. 6 is a first exemplary data structure for storing document information according to this invention;

FIG. 7 is a second exemplary data structure for storing document information according to this invention;

FIG. 8 is a third exemplary data structure for storing document information according to this invention;

FIG. 9 is a first exemplary data structure for storing document associations according to this invention; and

FIG. 10 is a second exemplary data structure for storing document associations according to this invention.

### DETAILED DESCRIPTION OF EXEMPLARY EMBODIMENTS

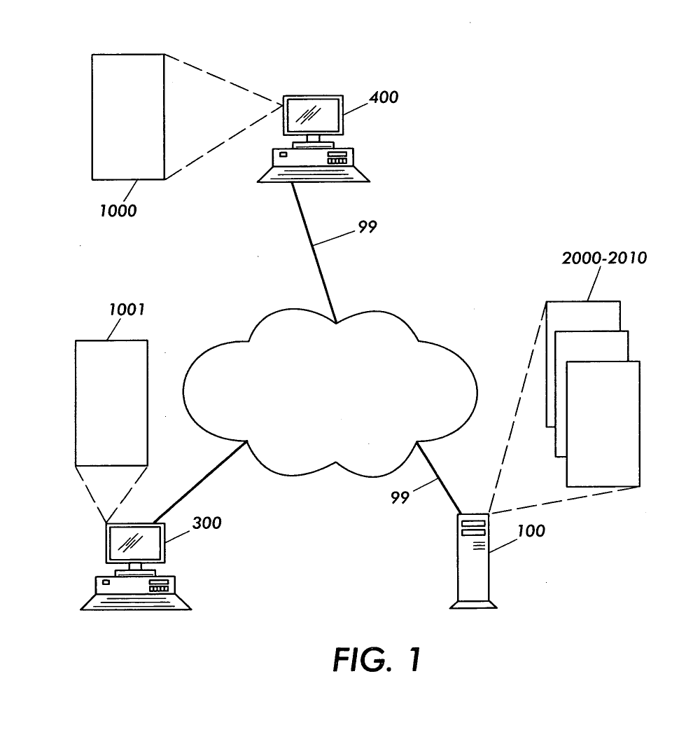

FIG. 1 is an exemplary overview of a system for creating and sharing information 100 according to this invention. First and second communications-enabled personal computers 300-400 are associated with primary documents 1000-1001. In one exemplary embodiment, the user of the first computer-enabled personal computer 300 selects a first primary document 1001 for review.

The additional information which may include review comments, discussion remarks, static links or content identifiers of documents related to the first primary document 1001 is forwarded over the communication links 99 to the system for creating and sharing information 100. In one exemplary embodiment, a system for reviewing the document such as the first communications-enabled personal computer 300, determines a document content identifier based on the content of the first primary document 1001, and associates it with the review comments of the respective document. The identifier is forwarded together with the review comments about the primary document 1001 over the communication links 99 to the system for sharing information 100 for storage and later retrieval. In this embodiment, the primary document 1001 does not travel across the communication links 99 of the network during the associated operations.

In other embodiments, the document content identifiers are created when the primary document is stored, when the document is created or at various other times before and/or simultaneously with the association of the primary document with another document.

In another embodiment, the primary document 1001 maybe sent over the communication links 99 to the system for creating and sharing information 100 in order to generate the document identifier. The first primary document content identifier is then forwarded over the communication links 99 to the first communications-enabled personal computer 300.

As additional documents 2000-2010 are created, document content identifiers are similarly created for these additional documents 2000-2010. In one exemplary embodiment, associations between the primary document 1001 and the additional documents 2000-2010 are created by saving the document content identifier of the primary document with the document content identifier of the additional documents. This association indicates that the additional document is related to, linked or connected to the primary document. In still other additional embodiments, documents are linked to the primary document by storing the document content identifier of the primary document with the document content identifier of additional documents in an association store of the system for creating and sharing information 100. However, it should be apparent that in various other exemplary embodiments according to this invention, the document content identifier may be determined by a document content identification manager, module or component executing on the communications-enabled personal computer 300. The document content identifier is then forwarded to the system for sharing information 100 over the communication links 99 reducing communication bandwidth requirements.

A user of the second communication-enabled personal computer 400 then requests a review of the second primary document 1000. In one exemplary embodiment, part or all of the system for creating and sharing information 100 is embedded within the second communications-enabled personal computer 400. For example, in some embodiments, a document content identification manager or module (not shown) is embedded within the communications-enabled personal computer 400. The embedded document content identification manager or module determines the primary document content identifier. The primary document content identifier is then forwarded via the communications links 99 to the system for creating and sharing information 100. The amount of information that needs to be shared over the communications links 99 is reduced since only the document content identifier is transmitted over the communications links 99. The distributed storage requirements of the primary documents are reduced while potentially increasing the processing speed.

The system for creating and sharing information 100 searches the association storage or memory for records associating the document content identifier of the primary document 1000 with the document content identifier of other additional documents 2000-2010. In one exemplary embodiment, the matching source and target document content identifiers are forwarded over the communication links 99 to the second communications-enabled personal computer 400. The second communications-enabled personal computer 400 then retrieves the additional documents. In still other embodiments, the system for creating and sharing information 100 directly retrieves the additional documents 2000-2010 associated with the matching document content identifiers and forwards the additional documents to the second communications-enabled personal computer 400 for display to the user.

It should be apparent that the system for creating and sharing information 100 may be embedded within an information repository, embedded within a computer or placed at any other accessible location within the network without departing from the spirit or scope of this invention. The primary and/or additional documents may be centrally located within an information repository, distributed to nodes within a network or to a distributed storage service providing a directory service and/or stored directly within the system for creating and sharing information 100, without departing from the scope of this invention. Moreover, it should be apparent that in various embodiments, the additional documents may be identified by unique document content identifiers, filesnames, URLs, and/or any other unique document content identifier.

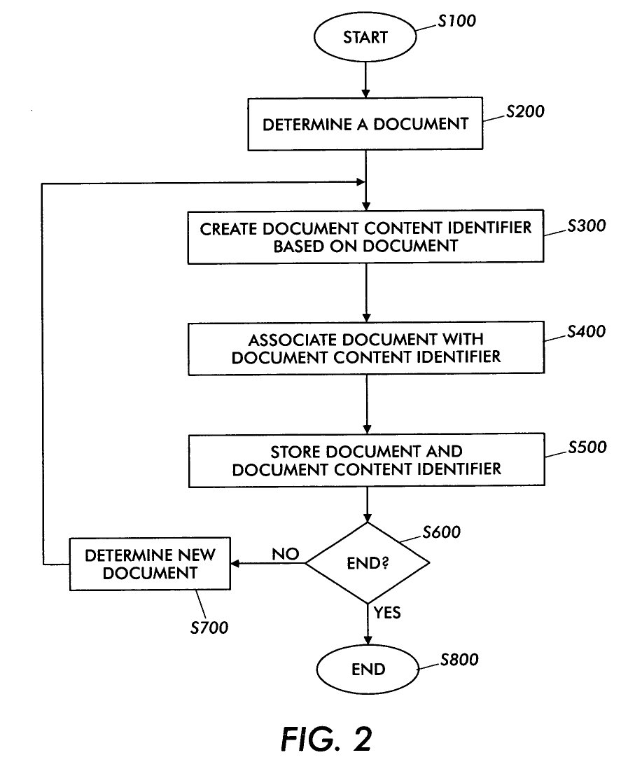

FIG. 2 is an exemplary method for creating and sharing information according to this invention. The process begins at step S100 and immediately continues to step S200. In step S200, a document is determined. In various exemplary embodiments according to this invention the filename of a document is entered using into a dialog box, chosen with a mouse or entered using any other known or later developed selection method. After the document has been selected, control continues to step S300.

A document content identifier is created based on the content of the primary document in step S300. The document content identifier may be determined based on a content-based fingerprint, a content-based citation, a content-based checksum, a content-based hash value and/or any other known or later developed method of generating a unique content-based uniform resource locator for the document. After the document content identifier has been determined, control continues to step S400.

In step S400, the document is associated with the document content identifier. In various embodiments according to this invention, the document is associated with the document content identifier by linking the document to the document content identifier using a database record, a linked list or the like. Once the document and the document content identifier have been associated, control continues to step S500.

The document and the document content identifiers are optionally stored within an information store or memory in step S500. In various embodiments, the document and the document content identifier are stored in locations local to and/or remote from the user. For example, a document may be retrieved from distributed or centrally located document or information repositories and transmitted over communications links. The document content identifier may be initially created and/or stored at the document repository, created and/or stored within a centralized storage system, created and/or stored at the user's communication-enabled computer and/or at any other location within the network. After the document and document content identifier have been stored, control continues to step S600.

In step S600, a decision is made as to whether the user has requested the end of the current session. In various embodiments, the program may programmatically request the termination of the current session. If a determination is made in step S600 that an end-of-session has not been requested, control continues to step S700 where a new document is determined. Control then jumps to step S300 and steps S300-S700 are repeated. If a determination is made in step S600 that an end of the session has been requested, control continues to step S800 and the process ends.

In another embodiment, S400 and S500 are omitted, because the identifier-document association is one-on-one and is automatically determined.

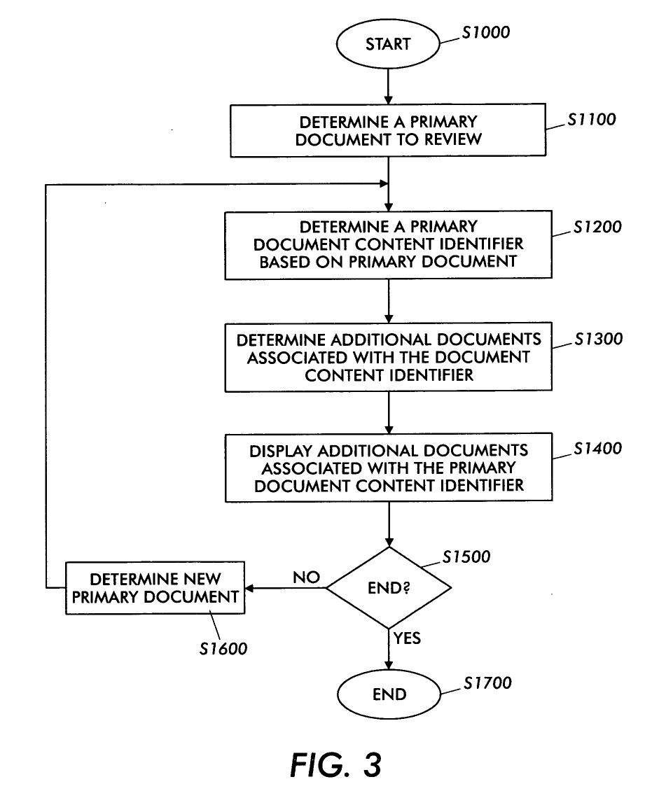

FIG. 3 is an exemplary method for displaying information according to this invention. The process begins at step S1000 and immediately continues to step S1100. A primary document for review is determined in step S1100. A filename entry dialog box, a cursor operation or the like is used to select the primary document or file. However, it will be apparent that in various other embodiments according to this invention, the primary document or file may be selected under program control or by using any other known or later developed selection method. After the primary document has been selected, control continues to step S11200.

A document content identifier is then determined based on the contents of the primary document. As discussed above, the primary document content identifier may be generated using a document fingerprint, content-based checksums, a content-based hash or any other operation or transformation capable of creating content-based uniform resource locator for each file. That is, two files having the same content but associated with two different filenames will be associated or mapped to the same content-based uniform resource locator. In some exemplary embodiments, the document content identifier is generated and stored within or with the document or is stored in another location accessible over the network. The document content identifier is then retrieved from the stored file or other accessible location. After the primary document content identifier has been determined, control continues to step S1300.

In step S1300, additional documents are retrieved from a document or information repository based on the primary document content identifier. That is, associations between additional documents and the primary document are created by associating the document content identifier of the primary document with each of the additional documents. The associations are stored with the additional documents, stored in a centralized comment store or at any other location within the network. After the additional documents have been retrieved, control continues to step S1400.

In step S1400, the additional documents associated with the primary document content identifier are displayed. After the additional documents have been displayed, control continues to step S1500 where a determination is made as to whether the end of session has been requested. If an end of session has not been requested, control continues to step S1600 where a new primary document is selected. Control then jumps to step S1200. Steps S1200-S1600 are repeated until it is determined in step S1500 that an end of session has been requested. Control then continues to step S1700 and the process ends.

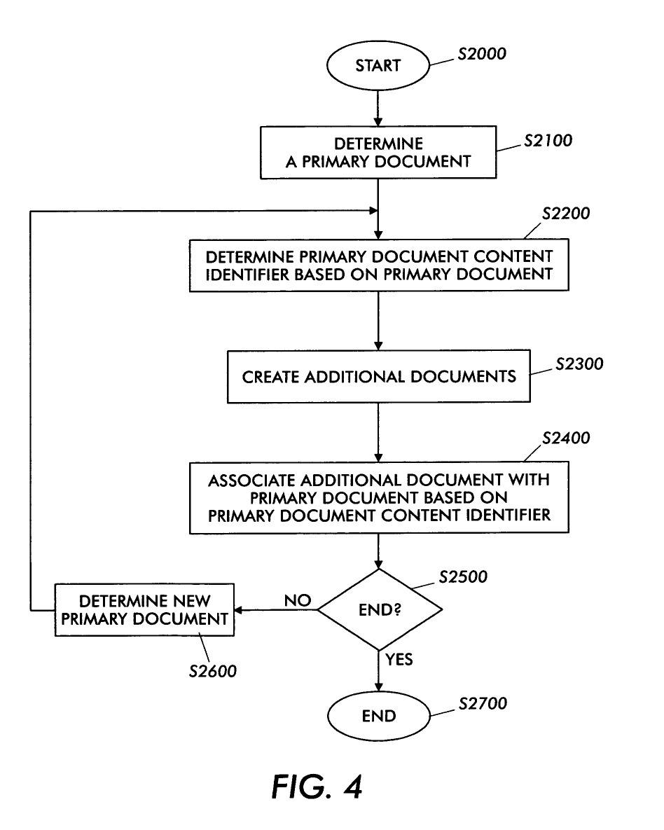

FIG. 4 is an exemplary method for creating and sharing information according to this invention. The process begins at step S2000 and immediately continues to step S2100.

In step S2100, a primary document is determined. The primary document may be determined using various known or later developed selection methods. For example, a user may determine a primary document by entering the name of a document into a dialog box, selecting the document using a cursor or the like. After the primary document has been determined, control continues to step S2200.

The primary document content identifier is determined based on the content of the primary document in step S2200. In various exemplary embodiments according to this invention, the document content identifiers are content-based document fingerprints, content-based checksums, content-based hash functions or various other known or later developed methods of creating unique uniform resource locators based on the content of the primary document. After the primary document content identifier has been determined, control continues to step S2300.

In step S2300, additional documents are created. The additional documents may include, but are not limited to comments, reviews and annotations of, or about the primary document. In still other exemplary embodiments according to this invention, the additional documents are previously created documents retrieved from an information store such as a digital library or the like. Document content identifiers are created for each of the additional documents. After the additional documents have been determined, created or retrieved, control continues to step S2400.

The additional documents are associated with the document content identifier of the primary document in step S2400. The associations may be stored in a database record, a linked list or the like and saved in memory, disk file or various other types of storage. In one exemplary embodiment, the association is comprised of the document content identifier of the additional document and the document content identifier of the primary document. Each pair of source-target document content identifiers reflects an association. After the additional documents have been associated with the primary document content identifier, control continues to step S2500.

In step S2500, a determination is made as to whether an end of session has been requested. The end-of-session may be indicated by the user selecting an end-of-session key sequence such as “CTRL-D”, “ESC”, selected automatically under program control or the like. If an end of session is not selected, control continues to step S2600 where a new primary document is determined. Control then continues to step S2200. Steps S2200-S2600 are then repeated until it is determined in step S2500 that an end of session has been selected. Control then continues to step S2700 and the process ends.

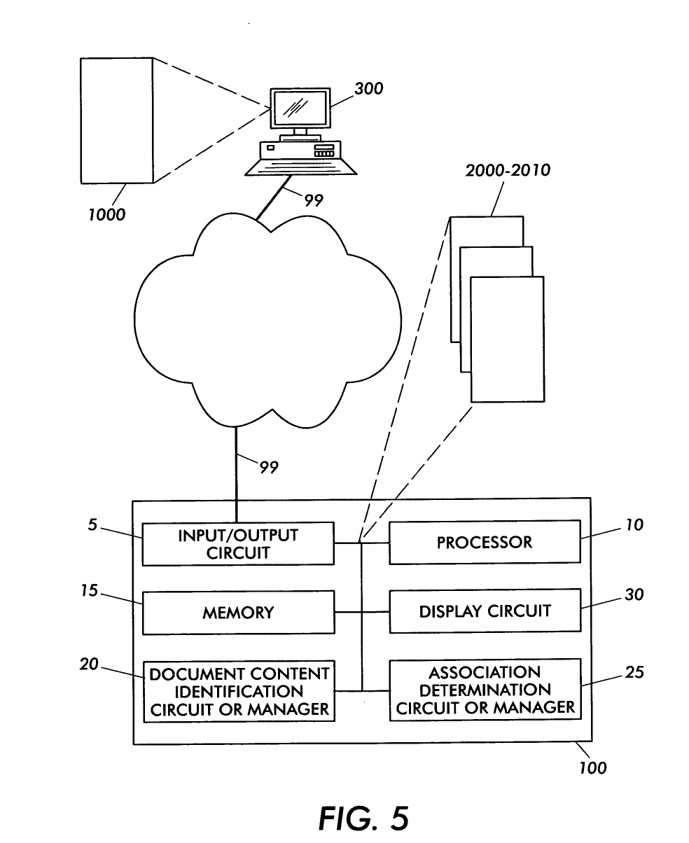

FIG. 5 is an overview of an exemplary system for creating and sharing information 100 according to this invention. The system for creating and sharing information is comprised of: a processor 10; a memory 15; a document content identification circuit or manager 20; an association determination circuit or manager 25 and a display circuit 30; each connected via input/output circuit 5 to communications links 99 and to a communications-enabled personal computer 300. The communications-enabled personal computer 300 stores a primary document 1000 while the system for creating and sharing information 100 stores additional documents 2000-2010.

In one exemplary embodiment, the user of the communications-enabled personal computer 300 retrieves and forwards the primary document 1000 to the system for creating and sharing information 100. The processor 10 of the system for creating and sharing information 100 activates the input/output circuit 5 to receive the primary document 1000 and stores it in memory 15. The processor 10 activates the document content identification circuit or manager 20 to determine a document content identifier for the primary document. The processor 10 then activates the association determination circuit or manager 25 to create an association between the primary document 1000 and the determined document content identifier and store the association in the memory 15. It should be apparent that in various other embodiments, the document content identifier is determined by a document content identification circuit or manager (not shown) executing on the communication-enabled personal computer 300.

The user of communications-enabled personal computer 300 and/or other users create or identify additional documents 200-2010 related to the primary document. The additional documents 2000-2010 are received over the communications links 99 by the input/output circuit 5 of the system for creating and sharing information 100. The processor 10 of the system for creating and sharing information 100 activates the document content identification circuit or manager 20 to determine document content identifiers for each document. The processor 10 activates the association determination circuit or manager 25 to associate the additional document content identifier with the document content identifier of the related primary document. The pairs of primary-additional document content identifiers are then stored in the association storage of the memory 15. It will be apparent that in various other embodiments, a unique URL or any other unique identifier associated with the additional documents may be used with the document content identifier of the primary document to create an association.

In a reviewing mode, the user of the communications-enabled personal computer 300 requests a list of the all documents associated with primary document 1000. A document content identifier of the primary document is determined and forwarded to the system for creating and sharing information 100. The system for creating and sharing information 100 retrieves the document content identifiers of related additional documents based on the document content identifier of the primary document. In one embodiment, the additional documents 2000-2010 associated with the additional document identifiers are stored in the memory 15. However, it should be apparent that the additional documents 2000-2010 may be stored at any location accessible via the communication links 99. The determined document content identifiers and/or the additional documents are then forwarded over the communications links 99 and displayed to the user of the communications-enabled personal computer 300.

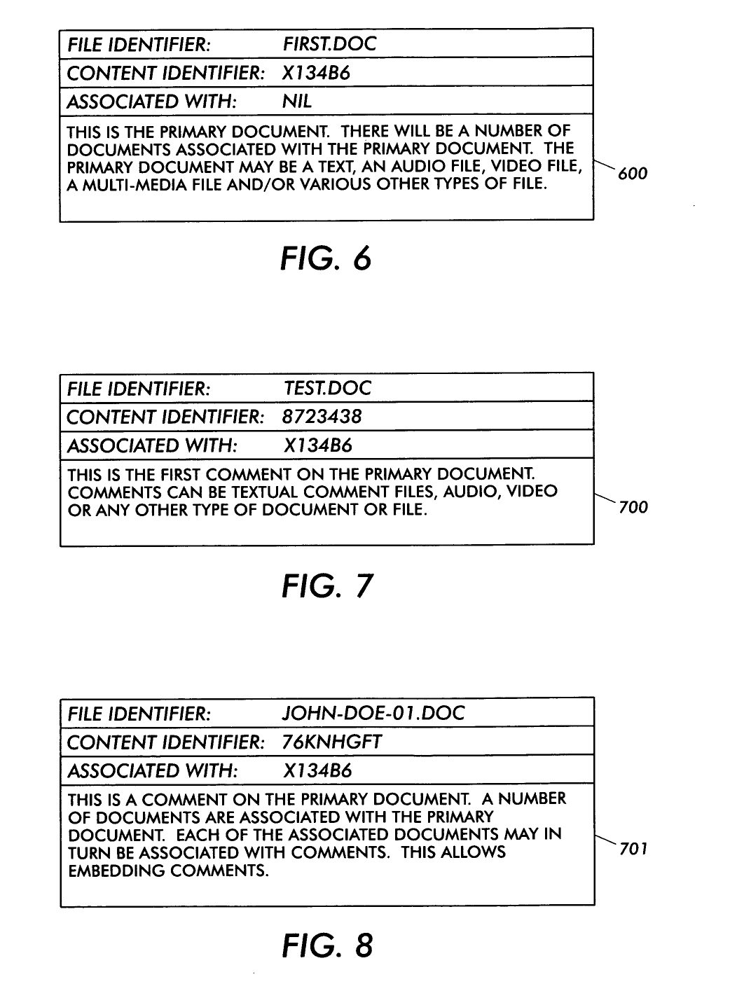

FIG. 6 is a first exemplary data structure for storing document information 600 according to this invention. The document data structure is comprised of a file identifier portion containing the value “FIRST.DOC”. This value identifies the file within directory folder or other portion of the local operating environment. However, the filename is not necessarily unique. Moreover, the same file may be duplicated across multiple information repositories, may exist at different subdirectories or locations and/or may be duplicated across one or more repositories using different file names.

The content identifier portion of the document data structure 600 contains the value “X134B6”. This value is determined using a content-based document fingerprint, a content-based hash or any other known or later developed method of determining a content-based Uniform Resource Locator.

The association portion of the document data structure 600 contains the value “NIL”. This indicates that the primary document is not associated with any additional documents. That is, the primary document is not itself another document or comment on a document. Comments, reviews or other documents are associated with the primary document based on the use of the document content identifier of the primary document in the association portion of the document data structure 600. Thus, a search for all documents containing the document content value “X134B6” will select all comments, reviews or additional documents associated with the primary document content identifier. This provides a link between the primary document and additional documents such as comments, reviews and the like.

FIG. 7 is a second exemplary data structure for storing document information 700 according to this invention. The first row of the second exemplary data structure for storing document information 700 contains the value “TEST.DOC” in the file identifier portion indicating a name for the file within the local file system.

The second row contains the value “8723438” in the document content identifier portion. This value can be used to associate more documents with the first additional document. That is, other files or documents associated with the value “8723438” in the association portion of the second exemplary data structure for storing document information 700 are comments, or are related to the file “TEST.DOC”.

The third row contains the value “X134B6”. This value indicates the primary document with which file “TEST.DOC” is associated. For example, the file “TEST.DOC” may contain comment about the file “FIRST.DOC” which is identified by the document content identifier “X134B6”.

FIG. 8 is a third exemplary data structure for storing document information 701 according to this invention. The first row contains the file identifier “JOHN-DOE-01.DOC”. This value may be used to identify the file within a local system, database, storage facility or other information repository. In some exemplary embodiments, a filename is a fully qualified filename that includes a unique machine identifier, the path as well as the name of the file.

The second row contains the value “76KNHGFT” in the document content identifier portion. This value can be used to associate more documents with the second additional document. That is, other files or documents associated with the value “8723438” in the association portion of the third exemplary data structure for storing document information 701 are comments, or are related to the file “JOHN-DOE-01.DOC”.

The third row contains the value “X1134B6”. This value indicates the primary document with which file “TEST.DOC” is associated. For example, the file “TEST.DOC” may contain comment about the file “FIRST.DOC” which is identified by the document content identifier “X134B6”.

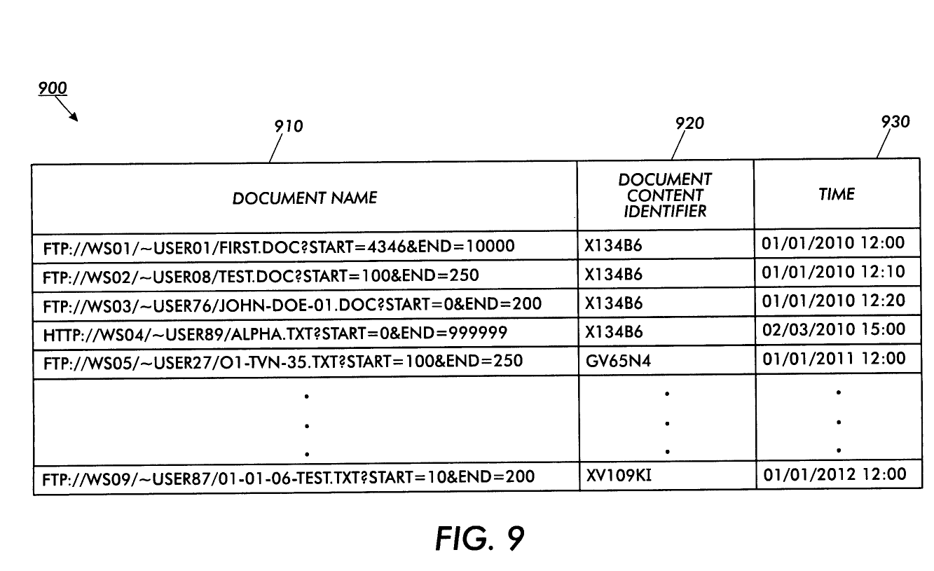

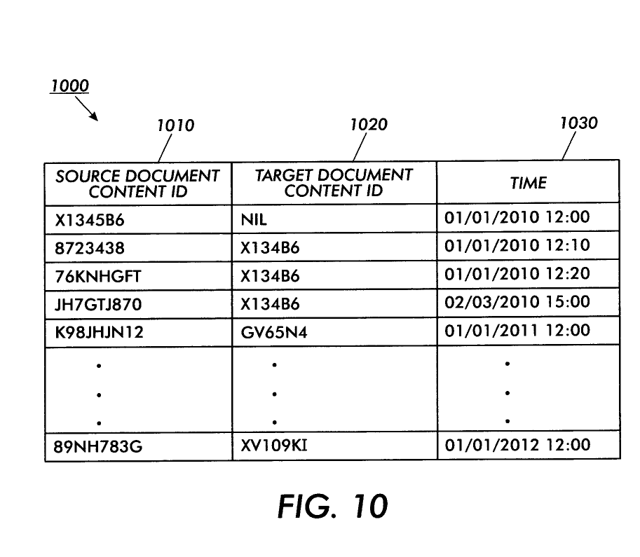

FIG. 9 is a first exemplary data structure for storing document associations 900 according to this invention. The data structure for storing document associations 900 is comprised of: a document name portion 910, a document content id portion 920 and an optional time portion 930.

The first row of the exemplary data structure for storing document associations 900 contains a value of “FTP://WS01/˜USER01/FIRST.DOC?START=4346&END=10000” in the document name portion 910. This identifies the document within the local operating storage environment. It will be apparent that the document name may be a file name, or any other Uniform Resource Locator. In the first row the value indicates the file “FIRST.DOC” is stored in the memory of “USER01” on machine “WS01” and is accessible using the FTP protocol. The relevant portion of the file starts at character 4346 and ends at character 10000.

The document content id portion 920 contains the value “X134B6”. This value is generated based on the content of the referenced document. In various exemplary embodiments, the value of the document content id for a document is created using a content-based hash value that creates a unique document content id value for every distinct document. In various other embodiments, the document content identifier value defines starting and ending points to more precisely specify relevant portions of the documents.

The optional time portion 930 of the exemplary data structure for storing document associations 900 contains the value “01/01/2010 12:00”. This value indicates that the document was created on Jan. 1, 2010 at 12:00 UCT/UTC. If the time information is synchronized to a centralized network time server using NTP or the like, the comments can be easily ordered for display.

The second row of the exemplary data structure for storing document associations 900 contains a value of “FTP://WS02/˜USER08/TEST.DOC?START=100&END=250” in the document name portion 910 identifying the document within the local operating storage environment. The “TEST.DOC” portion indicates the file “TEST.DOC” is stored in the memory or storage facility associated with user “USER08” on machine “WS02” and accessible via the FTP protocol. The relevant portion of the file starts at character 100 and ends at character 250.

The document content id portion 920 contains the value “X134B6”. This Uniform Resource Locator is generated based on the content of the referenced document.

The optional time portion 930 of the exemplary data structure for storing document associations 900 contains the value “01/01/2010 12:10” indicating the time the document was created.

The third row of the exemplary data structure for storing document associations 900 contains a value of “FTP://WS03/˜USER76/JOHN-DOE-01.DOC?START=0&END=200” in the document name portion 910 identifying the document within the local operating storage environment. The “JOHN-DOE-01.DOC” portion indicates the file “JOHN-DOE-01.DOC” is stored in the memory or storage facility associated with user “USER76” on machine “WS03” and accessible via the FTP protocol. The relevant portion of the file starts at character 0 and ends at character 200.

The document content id portion 920 contains the value “X134B6”. This Uniform Resource Locator is generated based on the content of the referenced document.

The optional time portion 930 of the exemplary data structure for storing document associations 900 contains the value “01/01/2010 12:20”, the time the document was created.

The fourth row of the exemplary data structure for storing document associations 900 contains a value of “FTP://WS04/˜USER89/ALPHA.TXT?START=0&END=999999” in the document name portion 910, the value “X124B6” in the document content id portion 920 and the value “02/03/2010 15:00” in the optional time portion 930.

These values indicate that the document “ALPHA.TXT” starting at character “0” and ending at character “999999” stored on machine “WS04” in the home directory of “user89” and accessible via the “http” protocol, created on “02/03/2010 15:00” is associated with the file associated with the document content identifier “X134B6”.

The fifth row of the exemplary data structure for storing document associations 900 contains a value of “FTP://WS05/˜USER27/01-TVN-35.TXT?START=100&END=250” in the document name portion 910, the value “GV65N4” in the document content id portion 920 and the value “01/01/2011 12:00” in the optional time portion 930.

These values indicate that the document “01-TVN-35.TXT” starting at character “100” and ending at character “250” stored on machine “WS05” in the home directory of “user27” and accessible via the “ftp” protocol, created on “01/01/2011 12:00” is associated with the file associated with the document content identifier “GV65N4”.

The last row of the exemplary data structure for storing document associations 900 contains a value of “FTP://WS09/˜USER87/01-01-06-TEST.TXT?START=10&END=200” in the document name portion 910, the value “XV109K1” in the document content id portion 920 and the value “01/01/2012 12:00” in the optional time portion 930.

These values indicate that the document “01-01-06-TEST.TXT” starting at character “10” and ending at character “200” stored on machine “WS09” in the home directory of “user87” and accessible via the “ftp” protocol, created on “01/01/2012 12:00” is associated with the file associated with the document content identifier “XV109K1”.

FIG. 10 is a second exemplary data structure for storing document associations 1000 according to this invention. The second exemplary data structure for storing document associations 100 is comprised of a source document content id portion 1010; a target document content id portion 1020; and an optional time portion 1030.

The first row of the second exemplary data structure for storing document associations 1000 contains the value “X1345B6” in the source document content id portion 1010. This value indicates the document content identifier of the primary document.

The target document content id portion 1020 contains the value “NIL” indicating that the document identified by the document content identifier “X134B6” is not a comment, review or additional comment about any other document. The optional time portion 1030 contains the value “01/01/2010 12:00” indicating when the document was created.

The second row of the second exemplary data structure for storing document associations 1000 contains the values “8723438”, “X134B6” and “01/01/2010 12:10”. These values indicate that the document identified by the document content identifier “8723438” is a comment or additional document related to the document identified by document content identifier “X134B6” and was created at Jan. 1, 2010 at 12:10.

The third row of the second exemplary data structure for storing document associations 1000 contains the values “76KNHGFT”, “X134B6” and “01/01/2010 12:20”. These values indicate that the document identified by the document content identifier “76KNHGFT” is a comment or additional document related to the document identified by document content identifier “X134B6” and was created at Jan. 1, 2010 at 12:20.

The fourth row of the second exemplary data structure for storing document associations 1000 contains the values “JH7GTJ870”, “X134B6” and “02/03/2010 15:00”. These values indicate that the document identified by the document content identifier “JH7GTJ870” is a comment or additional document related to the document identified by document content identifier “X134B6” and was created at Feb. 3, 2010 at 15:00.

The fifth row of the second exemplary data structure for storing document associations 1000 contains the values “K98JHJN12”, “GV65N4” and “01/01/2011 12:00”. These values indicate that the document identified by the document content identifier “K98JHJN12” is a comment or additional document related to the document identified by document content identifier “GV65N4” and was created at Jan. 1, 2011 at 12:11.

The last row of the second exemplary data structure for storing document associations 1000 contains the values “89NH783G”, “XV109K1” and “01/01/2012 12:00”. These values indicate that the document identified by the document content identifier “89NH783G” is a comment or additional document related to the document identified by document content identifier “XV109K1” and was created at Jan. 1, 2012 at 12:00.

In the various embodiments of the system for creating and sharing information 100, each of the circuits 5-30 outlined above can be implemented as portions of a suitably programmed general-purpose computer. Alternatively, 5-30 of the system for creating and sharing information 100 outlined above can be implemented as physically distinct hardware circuits within an ASIC, or using a FPGA, a PDL, a PLA or a PAL, or using discrete logic elements or discrete circuit elements. The particular form each of the circuits 5-30 of the system for creating and sharing information 100 outlined above will take is a design choice and will be obvious and predictable to those skilled in the art.

Moreover, the system for creating and sharing information 100 and/or each of the various circuits discussed above can each be implemented as software routines, managers or objects executing on a programmed general purpose computer, a special purpose computer, a microprocessor or the like. In this case, the system for creating and sharing information 100 and/or each of the various circuits discussed above can each be implemented as one or more routines embedded in the communications network, as a resource residing on a server, or the like. The system for creating and sharing information 100 and the various circuits discussed above can also be implemented by physically incorporating the system for creating and sharing information 100 into software and/or hardware system, such as the hardware and software systems of a web server or a client device.

As shown in FIG. 5, memory 15 can be implemented using any appropriate combination of alterable, volatile or non-volatile memory or non-alterable, or fixed memory. The alterable memory, whether volatile or non-volatile, can be implemented using any one or more of static or dynamic RAM, a floppy disk and disk drive, a write-able or rewrite-able optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

The communication links 99 shown in FIGS. 1 & 5, can each be any known or later developed device or system for connecting a communication device to the system for creating and sharing information 100, including a direct cable connection, a connection over a wide area network or a local area network, a connection over an intranet, a connection over the Internet, or a connection over any other distributed processing network or system. In general, the communication links 99 can be any known or later developed connection system or structure usable to connect devices and facilitate communication.

Further, it should be appreciated that the communication links 99 can be wired or wireless links to a network. The network can be a local area network, a wide area network, an intranet, the Internet, or any other distributed processing and storage network.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A system for creating and sharing information about documents comprising:
an input/output circuit;
a memory;
an input/output circuit which retrieves and stores a primary document identifier in the memory;
an association circuit that stores associations between the primary document and at least one additional documents based on the determined primary document content identifier in an association memory;
a processor for retrieving additional documents associated with a primary document based on the primary document content identifier stored in the association memory; and
a display circuit for generating a display of the retrieved additional documents.

2. The system of claim 1, in which the at least one additional documents are stored in at least one of: a centralized and a local repository.

3. The system of claim 1, in which primary documents are stored in at least one of: a centralized and a local repository.

4. The system of claim 1, further comprising the step of:
determining identifiers for the at least one additional documents;
associating the at least one additional documents with the primary document based on the document content identifier of the primary document.

5. The system of claim 1, in which the association between the at least one additional documents and the primary document specifies a sub-portion of the primary document.

6. The system of claim 1, in which the primary documents are not stored.

7. The system of claim 1, in which the primary document is at least one of: a text-based document, an image-based document, a video-based document, and an audio-based document.

8. The system of claim 1, in which the at least one additional documents are at least one of: text-based documents, an image-based document, video-based documents, and audio-based documents.

9. The system of claim 1, in which the centralized repository is at least one of: a digital library, a file server, an httpd server, an ftp server, a database server, a network store, and a distributed file store.

10. A computer-implemented method for creating and sharing information about documents comprising the steps of:
determining a primary document;
determine a document content identifier based on the content of the primary document;
determine at least one additional documents to be associated with the primary document; and
associating the at least one additional documents with the primary document based on the document content identifier in an association store;
selectively retrieving additional documents based on a match between the document content identifier of a search and primary document content identifiers in the association store; and
displaying one or more of the additional documents;

11. The method of claim 10, in which the at least one additional documents are stored in at least one of: a centralized and a local repository.

12. The method of claim 10, in which primary documents are stored in at least one of: a centralized and a local repository.

13. The method of claim 10, further comprising the step of:
determining identifiers for the at least one additional documents;
associating the at least one additional documents with the primary document based on the document content identifier of the primary document.

14. The method of claim 10, in which the association between the at least one additional documents and the primary document specifies a sub-portion of the primary document.

15. The method of claims 10, in which the primary document is not stored.

16. The method of claim 10, in which the primary document is at least one of: a text-based document, an image-based document, a video-based document, and an audio-based document.

17. The method of claim 10, in which the at least one additional documents are at least one of: text-based documents, an image-based document, video-based documents, and audio-based documents.

18. The method of claim 10, in which the centralized repository is at least one of: a digital library, a file server, an httpd server, an ftp server, a network store, a database store and a distributed file store.

19. A computer readable storage medium comprising computer readable program code embodied on the computer readable storage medium, the computer readable program code useable to program a computer to create and share information about documents comprising the steps of:
determining a primary document;
determine a document content identifier based on the content of the primary document;
determine at least one additional documents to be associated with the primary document; and
associating the at least one additional documents with the primary document based on the document content identifier.
